(19) United States
(12) Patent Application Publication
(10) Pub. No.: US 2005/0272570 A1
(43) Pub. Date: Dec. 8, 2005

(54) Anatomical shoulder pulley system

(76) Inventor: Norman Paul Gustafson, Pittsburgh, PA (US)

Correspondence Address: Norman P. Gustafson, 2508 Collins Rd., Pittsburgh, PA, 15235, US

(21) Appl. No.: 10/863,436

(22) Filed: Jun. 8, 2004

(51) Int. Cl. A63B 21/002; B32B 3/02; D04H 11/00; A63B 21/00

(52) U.S. Cl. 482/91; 482/135

(57) ABSTRACT

An anatomical shoulder pulley system for use in the rehabilitation of various shoulder conditions. The device provides a means of converting the linear pull of a rope and pulley system into rotary motion that approximates the arc described by anatomical or physiological motion of the shoulder. The device can be adjusted to provide passive or assisted motion in varied planes of shoulder motion such as forward flexion, external or internal rotation or scapular plane shoulder elevation. A door unit section of the device secures the device to a standard door and provides a base for the device. Another section of the device consists of an arced track and associated components. The arced track may be secured to the door unit in varied degrees of rotation. A rope with a handle on one end is routed over a pulley located at the top of the arced track. The other end of the rope is attached to a track rider that can easily move upward and downward within the arced track. A rope and handle are also attached to the track rider. The user grasps both handles. By pulling down on the free end handle, the handle attached to the arced track moves upward along the track assisting a person to move their shoulder in an arc that approximates anatomical or physiological movement.

### BACKGROUND—FIELD OF INVENTION

This invention relates to a device that can be used in shoulder rehabilitation to assist a person's shoulder movement in an arc that approximates the arc that is produced during active, non assisted motion.

### BACKGROUND—DESCRIPTION OF PRIOR ART

There are many shoulder injuries, surgeries or other conditions that require rehabilitation. Rotator cuff injuries, humeral fractures, and frozen shoulder are among this category. During the rehabilitation phase of these conditions it is often beneficial for the injured person to perform passive or assisted motion when they are not capable of performing full active range of motion. Passive or assisted range of motion has the positive affect of maintaining joint structure integrity and maintaining or restoring the proper length of muscles and connective tissue structures.

Devices that are known that can accomplish passive or assisted shoulder motion can be grouped into two categories, pulleys that use a downward motion of the opposite arm to lift the injured arm upward and continuous passive motion devices. There are a number of commercially available pulley systems. These systems consist of a rope with handles and a pulley that is attached to the top portion of a doorway. While these systems are effective in lifting the injured shoulder upward, they have the disadvantage of using linear forces (the straight angle pull of the rope) to produce rotary motion. This is problematic for the user as a linear upward force produces a force that translates the humerus upward and may result in close approximation of the humerus to the acromion. This is known as impingement. Impingement is often the very condition that caused the patient's initial problem. Simple pulley systems also have the disadvantage of pulling the shoulder into an adducted or internally rotated position. It is the consensus of therapists that during rehabilitation it is important to first move the shoulder in the “Scapular Plane”. The scapular plane is elevation of the shoulder in an arc that is about 30 degrees toward abduction from pure flexion or sagittal plane motion.

CPM's or continuous passive motion devices are machines that are based on the research of Dr. Robert B. Salter that demonstrated the benefits of safe continuous passive motion vs. immobilization in the treatment of injuries. Many of these devices are commercially available for the shoulder and other joints. These devices consist of electric motors and machined actuators to produce motion and are thus expensive. There remains therefore a real need for a device that can safely and inexpensively assist a person with shoulder motion in an arc that corresponds to physiologic or anatomical movement.

### OBJECTS AND ADVANTAGES

Accordingly, it is an object of the current invention to provide a device that can assist a person with shoulder movement through the range of motion.

It is a further object of the invention to provide a device that is capable of assisting shoulder motion in an arc that approximates anatomical motion.

It is a further object of the current invention to provide a device that can assist a person with forward flexion shoulder movement.

It is another object of the invention to provide a device that can be easily adjusted to assist with motion in planes other than forward flexion such as internal and external rotation and scapular plane elevation.

To accomplish these objectives, the device consists of a door unit that provides a base for the device that can be secured to any standard sized door. The door unit includes hardware for securing the unit to a door. There is a mating projection of cylindrical shape that projects outward toward the user from the door unit. (mating projection on door unit) A second section of the device includes an arced track unit. The shape of this arced track approximates the arc of normal shoulder motion. The arced track is tubular with a continuously running slot on the side of the track facing the user. Included in the arced track unit is a mating projection (mating projection on arced track). This mating projection fits inside the mating projection on the door unit. There is hardware associated with the mating projections so that the mating projection on the arced track can be rigidly secured to the mating projection on the door unit in any position of rotation. A pulley is attached to the top end of the arced track. A rope is routed over the pulley and inside the tubular arced track. At the bottom end of the arced track the rope is attached to a track rider that rides up and down the arced track during operation. A handle is located at the free end of the rope and a handle is also attached to the track rider.

### BRIEF DESCRIPTION OF THE DRAWINGS

FIG. 1 is a right side view of the invention being operated by a user.

FIG. 2 is a perspective view of the door unit of the invention

FIG. 3 is a top and front view of the door unit

FIG. 4 is a side view of a portion of the arced track with the arced track mating projection

FIG. 5 is a side view of the track rider and handle on track rider

FIG. 6 is a side view and cut away view of the pulley

FIG. 7 is a cut away view of the arced track, slot in arced track, track rider and rope and handle on track rider

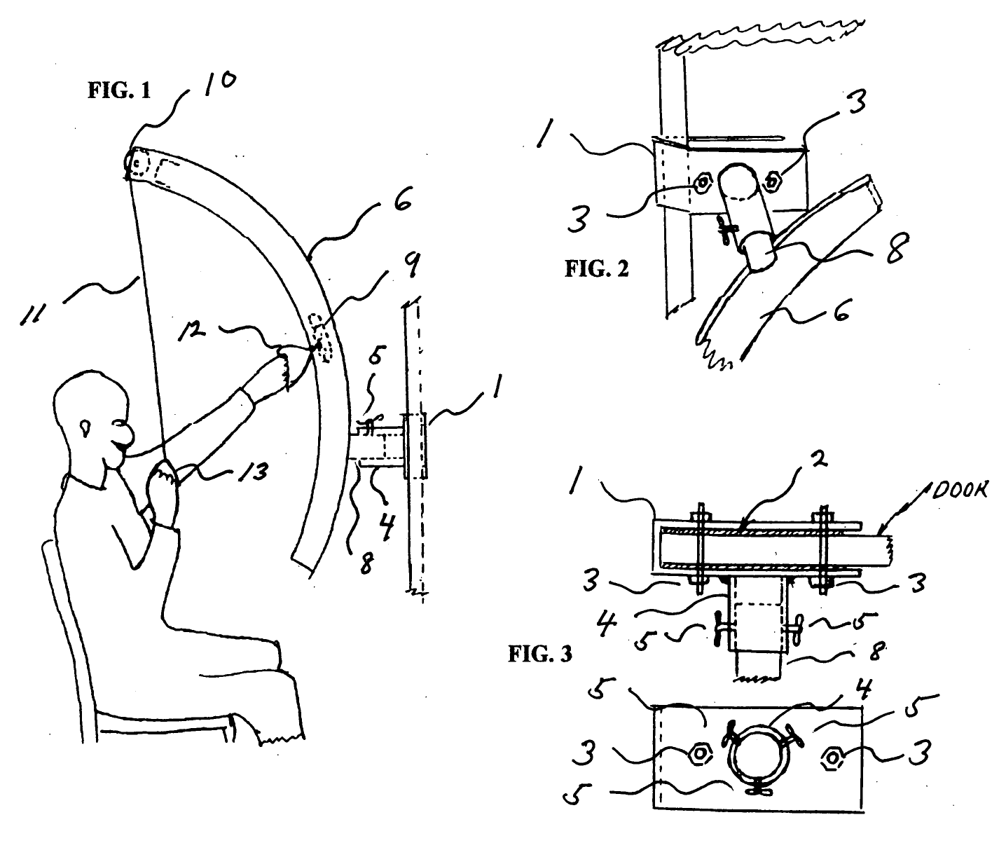

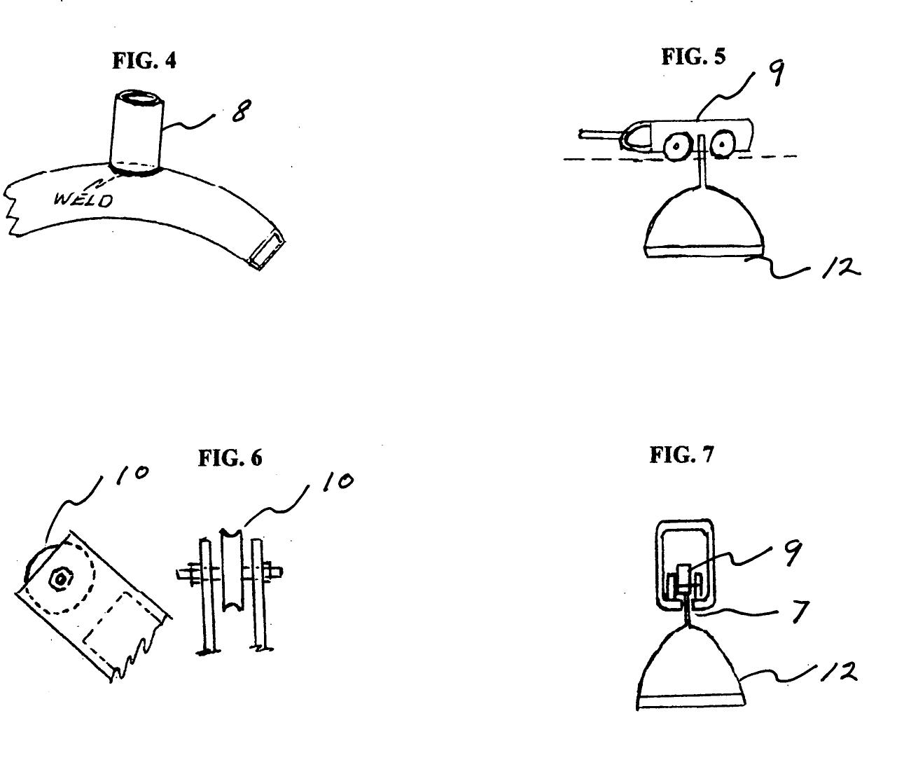

### DESCRIPTION OF PREFERRED EMBODIMENT

With reference to figures one through seven there is shown a typical embodiment of the current invention. A door unit 1 is in a “C” channel shape such that it fits over the width of a standard door. A door unit foam liner 2 is included on the inside of the door unit. Door unit bolts 3 are included for secure fastening of the door unit 1 to a standard door. A mating projection on door unit 4 projects outward from the door unit towards the user. Mating projection unit wing bolts 5 thread through the mating unit projection on door unit 4. A second section of the invention consists of an arced track 6 and components associated with it. The arced track is tubular and the shape of the arc is configured to approximate the arc described by a person's shoulder during shoulder flexion, abduction, etc. Along the length of the arced track is a slot in arced track 7. A mating projection on arced track 8 projects outward from the arced track and fits inside the mating projection on door unit 4. A track rider 9 is located inside the arced track 6 and has wheels so that it can easily travel inside the arced track 6. A pulley 10 is attached at the top of the arced track 6. A rope 11 is routed over the pulley. One end of the rope is attached to the track rider 9. The other end of the rope 11 is attached to a free end handle 13. Attached to the track rider is a track rider handle 12. Attached to the track rider handle 12 and the track rider 9 is a rope that fits in a slot in arced track 7.

### OPERATION

Referring to figures one through seven, a typical application of the invention is described. The door unit 1 is positioned on a door at the appropriate height for the user and then locked in place by tightening the door unit bolts 3. The arced track 6 with its associated mating projection on arced track 8 is positioned inside the mating projection on door unit 4. The user then rotates the arced track 6 and mating projection on arced track 8 to the desired angle of application with respect to the shoulder. For example pure sagittal plane shoulder flexion could be selected. Alternatively, Scapular plane shoulder motion could be selected. The mating projection wing bolts 5 are then tightened to secure the mating projection on arced track 8 to the mating projection on door unit 4 in the desired position. The user then holds the track rider handle 12 in the hand of the arm that assisted motion is desired of. The user then grasps the free end handle 13 in the opposite hand. By pulling down on the free end handle 13 tension is produced in the rope 11 that is routed over the pulley 10 and resultant tension is applied to the track rider 9. The tension pulls the track rider upward along the inside of the arced track 6. The user's arm that is holding the track rider handle 12 is pulled along the arced track 6 in an arc that approximates anatomical or physiological motion of the shoulder.

While a particular embodiment of the invention has been described above, it will be appreciated that numerous variations of the details may be made without departing from the invention as described in the appended claims. For example, a ball that slides or rolls in the arced track could be substituted for the track rider. Also, the door unit could be mounted over the top section of a door.

1. A shoulder anatomical motion pulley system comprising:
a. a door unit with means of securing said door unit to a door
b. an arced track unit providing means of converting the linear motion of a rope and pulley system into rotary motion
c. said door unit and said arced track unit having mating projections that provide a means of adjustably rotating and then securing said arced track unit to said door unit
d. a rope, pulley and handles
e. a track rider

2. The device of claim 1 wherein said door unit has a C channel shape with hardware means of securing the door unit to a door.

3. The device of claim 1 wherein said arced track unit is in an arced shape that approximates the arc described by anatomical shoulder movement.

4. The arced track of claim 3 wherein said arced track is tubular in shape and has a slot in arced track running along the length of said arced track.

5. The arced track of claim 3 wherein a track rider is positioned in said arced track enabling the track rider to easily move upward and downward inside the arced track.

6. Said rope of claim 1 wherein one end of the rope is attached to said track rider and the other end of the rope is attached to a free end handle.

7. Said handles of claim 1 wherein one handle is attached to the free end of the rope and the other handle is attached to said track rider.

8. Said pulley, rope, arced track and track rider of claim 1 wherein said rope is routed over said pulley located at the upper end of said arced track and said rope is attached to a free end handle on one end and said track rider on the other end such that pulling on the free end of the rope results in movement of the track rider and its attached handle along the arced track.
